(19) United States
(12) Patent Application Publication
(10) Pub. No.: US 2005/0235497 A1
(43) Pub. Date: Oct. 27, 2005

(54) Tension lever nutcracker

(76) Inventor: Terry Markwardt, Austin, TX (US)

Correspondence Address: DAVID ODELL SIMMONS, 7637 PARKVIEW CIRCLE, AUSTIN, TX, 78731, US

(21) Appl. No.: 10/831,794

(22) Filed: Apr. 26, 2004

(51) Int. Cl. B26B 17/00

(52) U.S. Cl. 30/120.3

(57) ABSTRACT

A nutcracker comprises an upper endplate that includes a plurality of spaced apart apertures defining a central portion of the upper endplate and a lower endplate includes a plurality of spaced apart apertures defining a central portion of the lower endplate. A plurality of spaced apart apertures of the lower end plate is spaced relatively close together with respect to the apertures of the upper end plate. The elongated rods each have ends thereof pivotably mounted within a corresponding one of the apertures of the upper and lower endplates to define a tapered and compressible nut envelope. Each one of the rod members includes an inner end portion at at least one end thereof and includes a shoulder provided at a surface of the inner end portion for engaging an inboard face of a corresponding one of the endplates to limit axial displacement of the rod members.

### FIELD OF THE DISCLOSURE

The disclosures made herein relate generally to methods and apparatuses for cracking nuts and, more particularly, to manual nutcrackers intended for use in a household environment.

### BACKGROUND

Nutcrackers of various constructions that are intended for use in a household environment are known. Examples of such conventional nutcrackers are screw-type nutcrackers, dual-lever type nutcrackers and inertia type (e.g., sliding mass) nutcrackers and the like. Such conventional nutcrackers are generally designed to allow a person to crack one nut at a time.

Such conventional nutcrackers are known to have one or more limitations that adversely affect their effectiveness and/or practicality. One limitation is that the shells of some nuts are not sufficiently cracked. Another limitation is that or too much of the meat within the shell is damaged while cracking the shell. Another limitation is that some conventional nutcrackers require relatively high hand strength to crack some types of nuts or to repeatedly crack nuts. Another limitation is that some conventional nutcrackers are not well suited for persons (e.g., elder persons) with hand-related health problems. Another limitation is that such conventional nutcrackers create significant debris (e.g., shards of nut shells) upon cracking of a nut and do little or nothing to contain such debris. Another limitation is that effective use of some conventional nutcrackers is dependent upon an acquired level of operating skill.

Therefore, a nutcracker that overcomes limitations associated with such conventional nutcrackers would be useful and novel.

### SUMMARY OF THE DISCLOSURE

It is a principal object of the inventive disclosures made herein to provide a novel and useful nutcracker that overcomes limitations associated with conventional nutcrackers. Specifically, nutcrackers in accordance with embodiments of the disclosures made herein more consistently crack the shells of nuts without damaging the meat of the nuts, reduce the hand strength required by the nutcracker to crack some types of nuts and to repeatedly crack nuts, are well suited for persons (e.g., elder persons) with hand-related health problems, reduce and/or contain debris (e.g., shards of nut shells) created upon cracking of a nut, and reduces dependency on an acquired level of operating skill being required to achieve desired results.

In one embodiment, a nutcracker comprises an upper endplate, a lower endplate and a plurality of elongated rods. The upper endplate includes a plurality of spaced apart apertures defining a central portion of the upper endplate. The lower endplate includes a plurality of spaced apart apertures defining a central portion of the lower endplate. The plurality of spaced apart apertures of the lower end plate is spaced relatively close together with respect to spacing of the apertures of the upper end plate. The plurality of elongated rods each have ends thereof pivotably mounted within a corresponding one of the apertures of the upper and lower endplates to define a tapered nut envelope thereby enabling the nut envelope to be compressible by relative rotation of the upper and lower endplates. Each one of the rod members includes an, inner end portion at at least one end thereof and includes a shoulder provided at a surface of the inner end portion for engaging an inboard face of a corresponding one of the endplates to limit axial displacement of the rod members with respect to the corresponding one of the end plates.

In another embodiment, a nutcracker comprising upper and lower endplates and a plurality of elongated rod members. Each one of the endplates includes a plate member having a central portion. The upper endplate plate member has an aperture-free central portion and a plurality of widely spaced apertures. The lower endplate plate member has a plurality of apertures closely spaced in the central portion thereof. The plurality of elongated rod members are loosely interfitted at ends thereof with the apertures in the upper and lower endplates to define a tapered nut envelope thereby enabling the nut envelope to be compressible by relative rotation of the upper and lower endplates. Each one of the rod members includes an inner end portion at at least one end thereof and includes a shoulder provided at a surface of the inner end portion for engaging an inboard face of a corresponding one of the endplates to limit axial displacement of the rod members with respect to the corresponding one of the end plates. Adjacent ones of the rod members are spaced apart to receive nuts into the nut envelope at the ends thereof interfitted to the upper endplate with the rod members being closely spaced at the ends thereof interfitted to the lower endplate. Accordingly, a nut admitted into the nut envelope between two adjacent ones of the rod members drops by gravity into contact engagement with the rod members at a lower position and cracking forces are applied to the nut by relatively rotating the upper and lower endplates.

In at least one embodiment of the inventive disclosures made herein each of the inner end portions has a tapered surface.

In at least one embodiment of the inventive disclosures made herein each one of the inner end portions has a generally non-tapered profile.

In at least one embodiment of the inventive disclosures made herein a compliant nut pouch is positioned within the nut envelope adjacent the lower end plate.

In at least one embodiment of the inventive disclosures made herein the shoulders are integral with the rod members.

In at least one embodiment of the inventive disclosures made herein shoulders of the rod members are comprised by a respective washer mounted on the inner end portion.

These and other objects of the inventive disclosures made herein will become readily apparent upon further review of the following specification and associated drawings.

### BRIEF DESCRIPTION OF THE DRAWINGS

FIG. 1 depicts a nutcracker in accordance with a first embodiment of the inventive disclosures made herein.

FIG. 2 is a sectional view taken along line 2-2 in FIG. 1.

FIGS. 3 and 4 depicts operation of the nutcracker depicted in FIGS. 1 and 2.

FIG. 5 depicts a wear pin for use in combination with the lower endplate of the nutcracker depicted in FIGS. 1 and 2.

FIGS. 6 and 7 depict resilient elements configured for securing rod members of the nutcracker depicted in FIGS. 1 and 2 to end plates of the nutcracker.

FIG. 8 depicts a nut pouch comprised by the nutcracker depicted in FIGS. 1 and 2.

FIG. 9 depicts a nutcracker in accordance with a second embodiment of the inventive disclosures made herein.

### DETAILED DESCRIPTION OF THE DRAWINGS

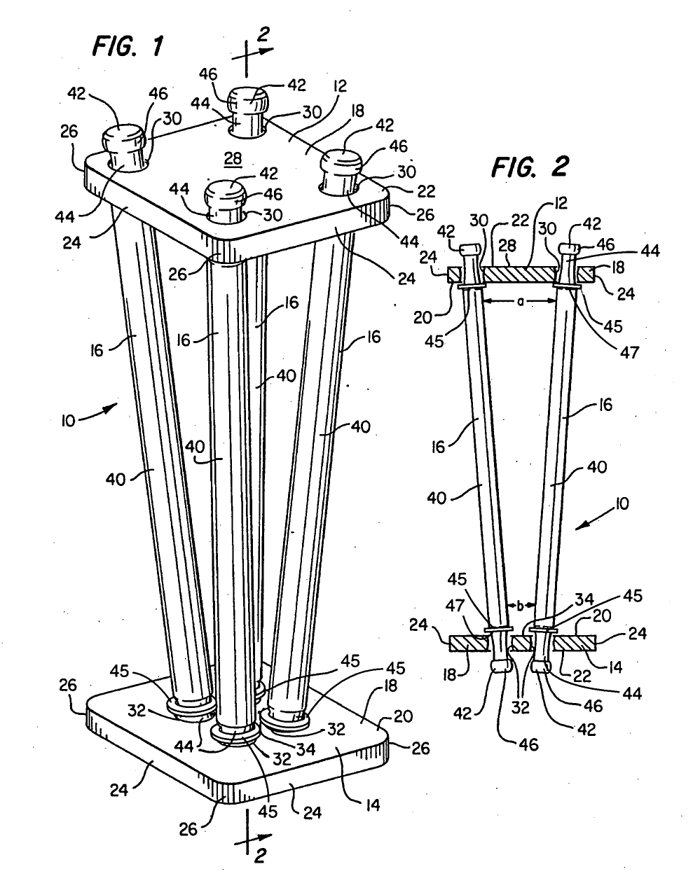

Referring initially to FIGS. 1 and 2, nutcracker 10 includes upper endplate 12, lower endplate 14 and four identical rod members 16. Each of the upper and lower endplates 12 and 14 includes a rectangular plate member 18 of substantially identical outer dimension. Plate members 18 include parallel planar inner and outer surfaces 20 and 22, respectively. Each plate member 18 also includes four side surfaces 24 of substantially equal length and being parallel on opposite sides and perpendicular on adjacent sides, such that the plate members 18 have substantially square horizontal cross-sections. Preferably, the corners of the plate members are rounded, as at reference numeral 26 in FIG. 1. Upper endplate 12 has an aperture-free central portion 28. Upper endplate 12 also includes walls defining four apertures 30 being widely spaced and in close proximity to the four corners thereof. In contrast, lower endplate 14 has walls defining four apertures 32 closely spaced in central portion 34 thereof.

The four identical elongated rod members 16 each include a cylindrical main portion 40 and two end portions 42. End portions 42 are defined by a tapered inner end portion 44 and a semi-spherical outer end portion 46. Outer end portions 46 are of smaller outer dimension than the main portions 40, but are of larger outer dimension than the adjoining inner end portions 44. Thus, when assembled as shown in FIGS. 1 and 2, the rod members 16 are loosely retained by apertures 30 and 32 to enable the relative rotation of endplates 12 and 14.

A washer 45 is mounted on the tapered inner end portion 44 of each one of the rod members 16. Each washer 45, which is an example of a discrete rod displacement limiter, defines a shoulder 47 at a surface of the tapered inner end portion 44 that engages an inboard face of a corresponding one of the endplates (12, 14). In this manner, the shoulder 47 defined by each washer 45 limits axial displacement of the rod members 16 with respect to the corresponding one of the end plates (12, 14). By limiting such axial displacement, binding of the tapered inner end portion 44 within the corresponding aperture 30 is reduced (e.g., by ensuring that sufficient clearance in maintained between the tapered inner end portion 44 and aperture (30, 32) of the end plates (12, 14). Reducing such bind is beneficial as it allows the rod members 16 to freely pivot even when the end plates (12, 14) are pushed inward during operation of the nutcracker 10.

As best shown in FIG. 2, adjacent ones of the rod members 16 are widely spaced apart at the ends thereof interfitted to upper endplate 12, whereas adjacent ones of the rod members 16 are closely spaced at the ends interfitted to lower endplate 14. Preferably, dimension “a”, which is defined as the space between adjacent ones of rod member 16 in the vicinity of the upper endplate, is in the range of about 1.25 inches to about 2.50 inches to enable admission of nuts having dimensions of the typical pecan, walnut or Brazil nut. The rod members 16 define a tapered nut envelope, which becomes smaller in the downward direction, such that nuts admitted into the nut envelope drop by gravity into contact engagement with rod members 16 at a lower position. Preferably, dimension “b”, which is defined as the spacing between rod members 16 in the vicinity of ends interfitted with the lower end plate 14, is in the range of about 0.25 inch to about 1.50 inch. The overall length of rod members 16 is preferably about 9 inches, and the preferred combination of dimensions “a”, “b” and rod length enable utilization of the nutcracker with substantially all types of nuts typically encountered in home use.

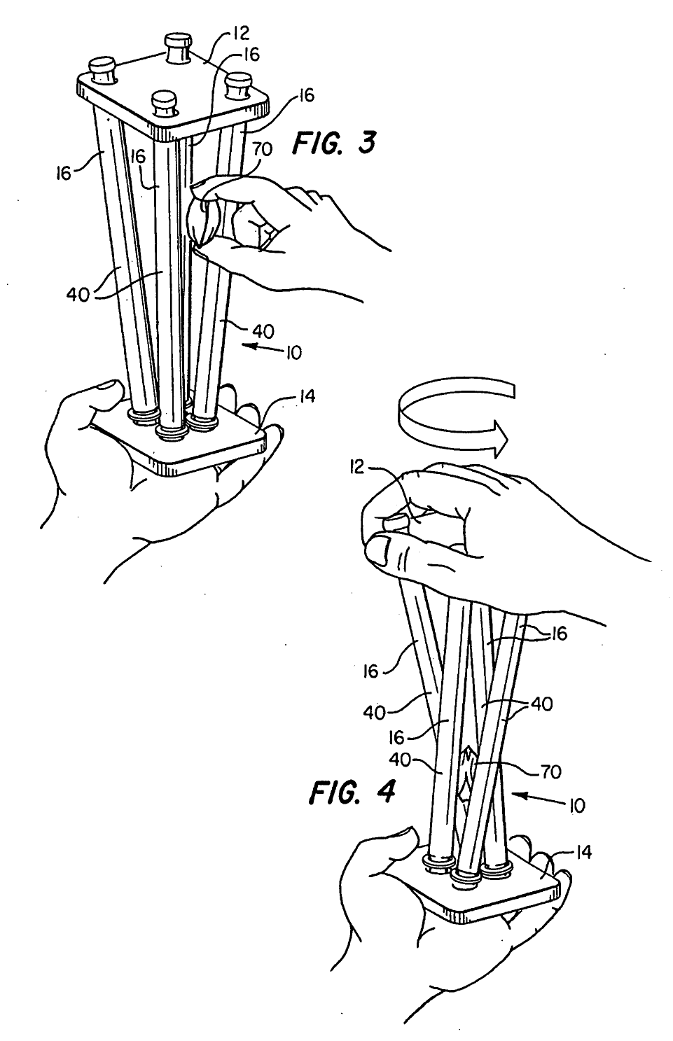

In operation, as shown in FIGS. 3 and 4, a nut 70 is admitted between the rod members 16 at a position above the point where the spacing of rod members 16 is greater than the smallest outer dimension of the nut 70. Nut 70 then drops by gravity into contact engagement with the main portions 40 of rod members 16. Relative rotation of endplates 12 and 14, as shown in FIG. 4, causes the nut envelope defined by rod members 16 to compress, thereby applying cracking forces to nut 70. Relative rotation and the resulting cracking forces are slowly increased until such time as the nut shell is sufficiently cracked to enable removal of the nut meat, at which time the endplates are relatively rotated back to the normal position, thereby expanding the nut envelope. Nutcracker 10 may then be inverted to remove the cracked nut.

For example, should the aperture pattern of upper endplate 12 have a radii of 1.59 inches and the aperture pattern of lower endplate 14 have a radii of 0.62 inches, then the rod member center radii at a point midway between upper endplate 12 and lower endplate 14 would be 1.105 inches. Upon a relative rotation of the endplates of 30.degree., the midway radii between the rod members is reduced by ((radii 1.59−(1.59*cosin 15.degree.)))=0.054 inches)+((radii 0.62−(0.62*cosin 15.degree.))=0.021 inches) for a resulting midway radii reduction of 0.075 inches. Thus the midway radii of the rod members is reduced from 1.105 inches to 1.030 inches, providing an inward movement of 0.075 inches for each of the rod members. Because the aperture pattern radii at each of the endplates is constant, the closer nut 70 is to either endplate 12 or 14, the greater the leverage. A point equal to one-fourth of the nut envelope height would reduce the starting rod member center radii to 0.863 inches. A relative rotation of 30 degrees would reduce the rod member center radii to 0.828 inches. Should the imaginary circumference of the endplates (across the corners) be 14.4 inches, then the torsion leverage at the midway point would be 8 to 1, with a leverage of 16 to 1 at one-fourth height.

The placement of nut 70 in the nutcracker 10 is not critical. A nutcracker having the preferred dimensional configuration results in the highly desirable result of cracking pecans with a high percentage of full halves. This is caused by the slow energy transfer to the shells being uneven due to the configuration of the nuts (not round), which requires less torque. As the shell becomes distorted outwardly in one direction, it becomes confined in that direction, highly stressing the shell with a minimum inward movement and with a large portion of the potential energy of the stress on the shell going into its cracking rather than the scattering of the shell fragments.

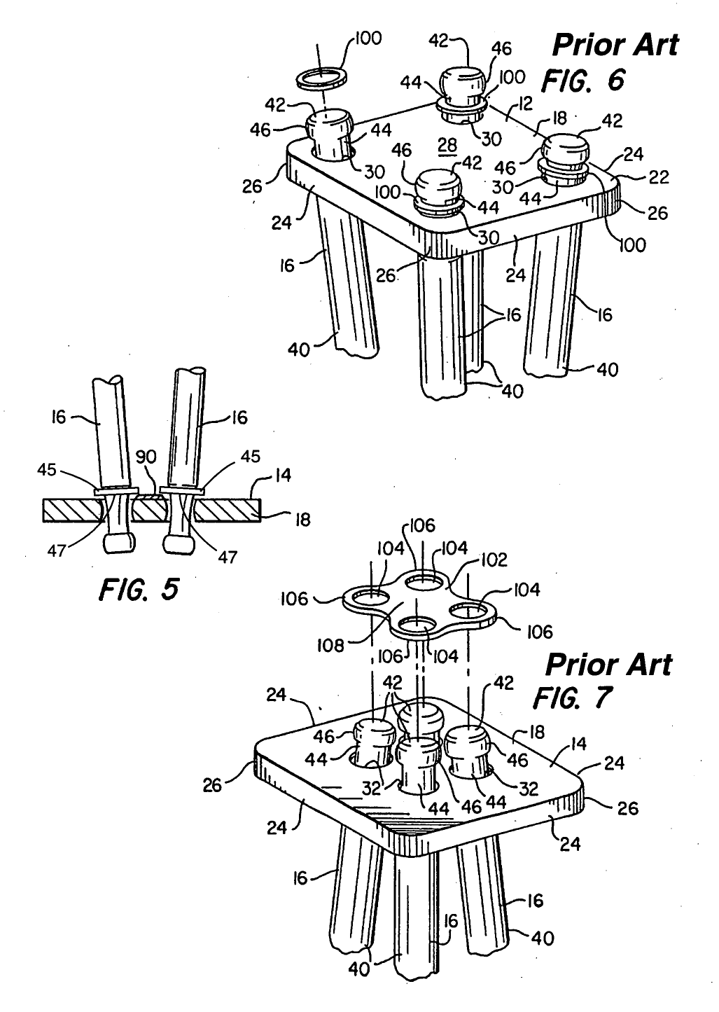

An important feature of the invention is the simple manufacturing and assembling technique enabled by the use of a compressible material for the rod members and endplates. Using precision manufacturing, the apertures are dimensioned slightly smaller than the outer end portions of the rod members, such that the ends of the rod members are press fittable into the apertures. Once fitted, the rod members are loosely retained by the apertures, and the nutcracker will not come disassembled unless substantially higher than normal force is applied to disengage the rod members from the endplates. Preferably, a wooden material is used for at least the rod members or the endplates, or both. Other suitable materials include certain plastics, ceramic material, metallic materials (e.g., aluminium or steel) and composite materials (e.g., carbon fiber, Kevlar or fiber glass). As shown in FIG. 5, replaceable wear pin 90 of harder material may also be placed in the central portion of plate member 18 of lower endplate 14, to prevent damage to the lower endplate 14 when cracking relatively small sized native nuts.

Alternatively, as shown in FIGS. 6 and 7, resilient retaining elements may be used in lieu of or in addition to the press-fitted engagement of rod members 16 and endplates 12 and 14. As best shown in FIG. 6, resilient retaining washers 100 engage the outer end portions 46 of the end portions 42 interfitted with upper endplate 12. Washers 100 are sized such that their greatest dimensions are well in excess of the opening sizes of apertures 30. Specifically, each washer 100 is a ring-shaped member being approximately as tall in the axial direction as the thickness between the inner and outer cylindrical walls. In similar fashion, as shown in FIG. 7, a resilient harness member 102 is fitted over the outer end portions 46 of the end portions 42 interfitted with lower endplate 14. Harness member 102 has four apertures 104 in lobes 106 grouped about a central portion 108. Harness member 102 has flat upper and lower surfaces spaced equidistantly to form a harness member 102 of uniform thickness. In similar fashion washer members 100 have flat upper and lower surface equally spaced to form a uniformly thick washer member 100.

In one embodiment, washer members 100 and harness member 102 are formed of a urethane plastic material of approximately 60 durometer. However, it is contemplated and disclosed herein that other resilient and/or compliant materials may be used. Examples of such other resilient and/or compliant materials include rubber, leather and other polymeric materials besides urethane.

Washers 100 and harness 102 compensate for wear between the rod members 16 and endplates 12 and 14, such that as these relatively moving parts wear, the press-fitted engagement does not become compromised to the extent that the interfitted parts become disengaged. In other words, the resilient washers 100 and harness 102 serve to back-up the engagement maintained by the close tolerances between the apertures and rod member ends. Thus, utilization of the resilient washers 100 and harness 102 results in a nutcracker having a substantially longer duty cycle for “heavy-duty” nutcracking environments. Alternatively, it will be recognized that the provision of resilient retaining washers 100 and harness 102 could be utilized to eliminate the precision wood-working required to allow press-fittable interfitting of the rod members 16 and endplates 12 and 14. In such an embodiment, the resilient washers and harness members substitute for the precision wood-working rather than add to the interfitting capability thereof.

It is disclosed and contemplated herein that the harness member 102 serves as a return spring for at least partially returning the nutcracker 10 to a static position (i.e., a position ready to receive a nut within the nut envelope). In particular, when a means for reducing binding between the rod members 16 and the end plates (12, 14) is employed (e.g. washers 45 depicted in FIGS. 1-5), the resilient nature of the harness member 102 acts to return the nutcracker to the static position when rotational force applied by a user is removed from the endplates (12, 14). Factors such as the degree of resilience and dimensions of the harness member 102, dimensions of the apertures of the endplates (12, 14), dimensions of the end portions of the rod member 16, clearance between the rod members 16 and the endplates (12, 14) will influence the degree to which the harness member 102 serves as a return spring.

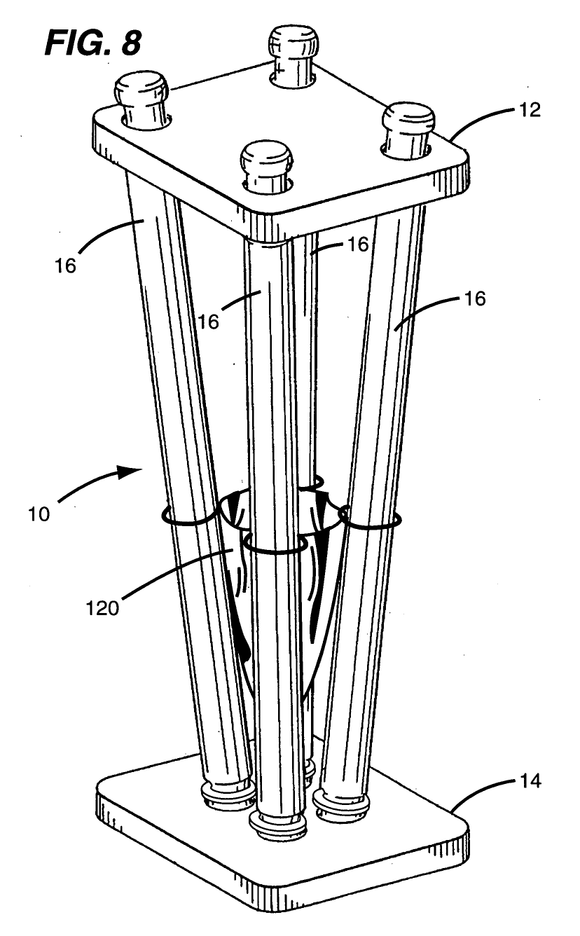

Alternately, referring to FIG. 8, the nutcracker 10 (i.e., a nutcracker in accordance with an embodiment of the inventive disclosures made herein) includes a nut pouch 120 positioned within the nut envelope defined by the rod members 16 adjacent the lower end plate 16. During operation of the nutcracker 10, a nut is placed in the nut pouch 120 such that debris generated while cracking the shell is contained within the nut pouch 120. Preferably, the nut pouch 120 is attached to at least a portion of the rod members 16 (e.g., via adhesive, thread, elastic bands, hook and loop fasteners or the like) and is made from a compliant material (e.g., fabric, plastic, leather or the like).

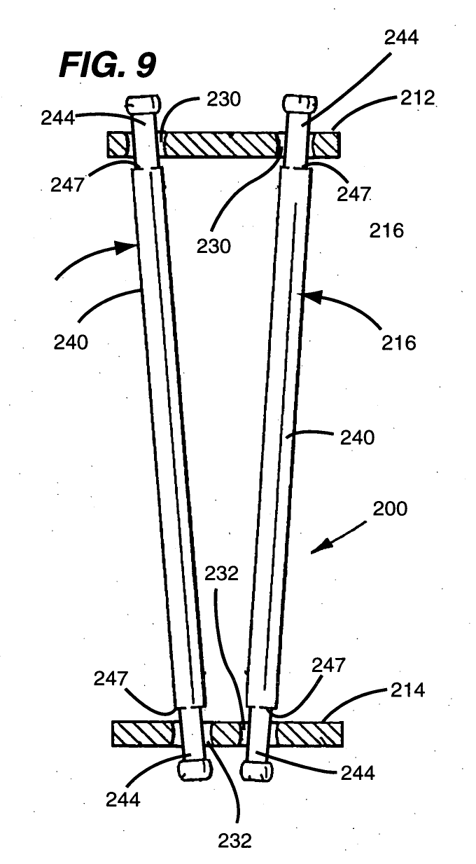

FIG. 9 depicts a nutcracker 200 including an upper endplate 212, a lower end plate 214 and a plurality of rod members 216. The upper endplate 212 has a plurality of apertures 230 therein. The lower endplate 214 has a plurality of apertures 232 herein. The elongated rods each have ends thereof pivotably mounted within a corresponding one of the apertures of the upper and lower endplates to define a tapered nut envelope that is compressible by relative rotation of the upper and lower endplates. The rod members 216 each have a cylindrical main portion 240 and non-tapered (e.g., cylindrical) inner end portions 244. A shoulder 247 that engages an inboard face of a corresponding one of the endplates (212, 214) is defined at the transition between the cylindrical main portion 240 and the non-tapered inner end portions 244 of each one of the rod members 216. The shoulder 247 limits axial displacement of the rod members 216 with respect to the corresponding one of the end plates (212, 214). Each non-tapered inner end portion 244 has a diameter sized appropriately with respect to corresponding diameters of the apertures (230, 232) of the end plates (212, 214), such binding of the non-tapered inner end portions 244 within the corresponding apertures (230, 232) is reduced. Reducing such binding is beneficial as it allows the rod members 216 to freely pivot even when the end plates (212, 214) are pushed inward during operation of the nutcracker 200.

Whereas the present invention has been described with respect to specific embodiments thereof, it will be understood that various changes and modifications will be suggested to one skilled in the art and it is intended to encompass such changes and modifications as fall within the scope of the appended claims.

1. A nutcracker comprising:
an upper endplate including a plurality of spaced apart apertures defining a central portion of the upper endplate;
a lower endplate including a plurality of spaced apart apertures defining a central portion of the lower endplate, the plurality of spaced apart apertures of the lower end plate being spaced relatively close together with respect to spacing of said apertures of the upper end plate; and
a plurality of elongated rods each having inner ends portions thereof pivotably mounted within a corresponding one of said apertures of the upper and lower endplates to define a tapered nut envelope thereby enabling said nut envelope to be compressible by relative rotation of said upper and lower endplates, wherein a main portion of each one of said elongated rods is non-tapered immediately adjacent said inner end portions of the respective one of said elongated rods, wherein each one of said inner end portions is non-tapered immediately adjacent the main portion of the respective one of said elongated rods and has a smaller cross-sectional size than the main portion of a respective one of said elongated rods such that a shoulder defined at a transition point between each one of said inner end portions and the main portion of the respective one of said elongated rods engages an inboard face of a corresponding one of said endplates to limit axial displacement of said elongated rods with respect to the corresponding one of said end plates.

2. (canceled)

3. The nutcracker of claim 1 wherein each one of said inner end portions is non-tapered along an entire length thereof.

4. The nutcracker of claim 1 further comprising:
resilient retaining elements fitted over outer end portions of said elongated rods for maintaining said pivotably mounted relationship between said rod member ends and said upper and lower endplates.

5. The nutcracker of claim 1, further comprising:
a compliant nut pouch positioned within said nut envelope adjacent said lower end plate.

6. (canceled)

7. (canceled)

8. (canceled)

9. (canceled)

10. A nutcracker comprising:
an upper endplate including a plurality of spaced apart apertures defining a central portion of the upper endplate;
a lower endplate including a plurality of spaced apart apertures defining a central portion of the lower endplate, the plurality of spaced apart apertures of the lower end plate being spaced relatively close together with respect ;to spacing of said apertures of the upper end plate;
a plurality of elongated rods each having inner ends portions thereof pivotably mounted within a corresponding one of said apertures of the upper and lower endplates to define a tapered nut envelope thereby enabling said nut envelope to be compressible by relative rotation of said upper and lower endplates, wherein a main portion of each one of said elongated rods is non-tapered immediately adjacent said inner end portions of the respective one of said elongated rods, wherein each one of said inner end portions is non-tapered immediately adjacent the main portion of the respective one of said elongated rods and has a smaller cross-sectional size than the main portion of a respective one of said elongated rods such that a shoulder defined at a transition point between each one of said inner end portions and the main portion of the respective one of said elongated rods engages an inboard face of a corresponding one of said endplates to limit axial displacement of said elongated rods with respect to the corresponding one of said end plates; and
a compliant nut pouch positioned within said nut envelope adjacent said lower end plate.

11. A nutcracker comprising:
upper and lower endplates, each one of said endplates including a plate member having a central portion, said upper endplate plate member have an aperture-free central portion and a plurality of widely spaced apertures, and said lower endplate plate member have a plurality of apertures closely spaced in said central portion thereof; and
a plurality of elongated rods loosely interfitted at inner ends portions thereof with said apertures in said upper and lower endplates to define a tapered nut envelope thereby enabling said nut envelope to be compressible by relative rotation of said upper and lower endplates, wherein a main portion of each one of said elongated rods is non-tapered immediately adjacent said inner end portions of the respective one of said elongated rods, wherein each one of said inner end portions is non-tapered immediately adjacent the main portion of the respective one of said elongated rods and has a smaller cross-sectional size than the main portion of a respective one of said elongated rods such that a shoulder defined at a transition point between each one of said inner end portions and the main portion of the respective one of said elongated rods engages an inboard face of a corresponding one of said endplates to limit axial displacement of said elongated rods with respect to the corresponding one of said end plates;
wherein adjacent ones of said elongated rods being spaced apart to receive nuts into said nut envelope at said ends thereof interfitted to said upper endplate, with said elongated rods being closely spaced at said ends thereof interfitted to said lower endplate, such that a nut admitted into said nut envelope between two adjacent ones of said elongated rods, drops by gravity into contact engagement with said elongated rods at a lower position, and cracking forces are applied to said nut by relatively rotating said upper and lower endplates.

12. The nutcracker of claim 11 wherein each one of said inner end portions has a non-tapered profile along an entire length thereof.

13. (canceled)

14. The nutcracker of claim 11 further comprising:
resilient retaining elements fitted over outer end portions of said elongated rods for maintaining said interfitted relationship between said rod member ends and said upper and lower endplates.

15. The nutcracker of claim 11, further comprising:
a compliant nut pouch positioned within said nut envelope adjacent said lower end plate.

16. (canceled)

17. (canceled)

18. (canceled)

19. (canceled)
